(19) United States
(12) Patent Application Publication
(10) Pub. No.: US 2026/0186853 A1
(43) Pub. Date: Jul. 2, 2026

(54) RESOURCE MANAGEMENT APPARATUS USING MULTI-LAYER ARCHITECTURE TO PERFORM RESOURCE IDENTIFIER MANAGEMENT AND RELATED RESOURCE MANAGEMENT METHOD

(71) Applicant: Airoha Technology (Suzhou) Limited, Suzhou City (CN)

(72) Inventors: PENG DU, Nanjing City (CN); Fei Yan, Nanjing City (CN)

(73) Assignee: Airoha Technology (Suzhou) Limited, Suzhou City (CN)

(21) Appl. No.: 19/406,889

(22) Filed: Dec. 2, 2025

(30) Foreign Application Priority Data
Dec. 31, 2024 (CN) 202412000338.3

(51) Int. Cl. G06F 9/50

(52) U.S. Cl. CPC G06F 9/5061; G06F 9/5016

(57) ABSTRACT

A resource management apparatus includes a processor, a resource management circuit, and a second memory. The processor includes an internal memory. The resource management circuit includes a first memory, wherein an access speed of the first memory is higher than an access speed of the second memory. The resource management circuit is arranged to load a plurality of first resource identifiers stored in the second memory into the first memory, and return a plurality of second resource identifiers stored in the first memory to the second memory. The resource management circuit is further arranged to load a plurality of third resource identifiers stored in the first memory into the internal memory, and return a plurality of fourth resource identifiers stored in the internal memory to the first memory.

### BACKGROUND OF THE INVENTION

### 1. Field of the Invention

The present invention relates to resource identifier management, and more particularly, to a resource management apparatus using a multi-layer architecture to perform resource identifier management and a related resource management method.

### 2. Description of the Prior Art

A network processing unit (NPU) is a high-speed programmable processor specifically designed for network packet processing (e.g., network packet forwarding). It has certain functions and architectures that can be used to accelerate the processing efficiency of network packets. However, with the continuous increase in the network bandwidth, network packets are transmitted at a higher rate, which requires the NPU to be able to quickly process these high-speed incoming network packets. In addition, the packet forwarding process often requires the use of various resources, and the use of resources will cause a certain degree of operational overhead. Generally speaking, the use of resources can be realized with the aid of resource identifiers. How to quickly and efficiently manage a large number of resource identifiers to prevent the packet forwarding performance from being degraded by the operational overhead of resources has become an important topic.

### SUMMARY OF THE INVENTION

One of the objectives of the claimed invention is to provide a resource management apparatus using a multi-layer architecture to perform resource identifier management and a related resource management method.

According to a first aspect of the present invention, an exemplary resource management apparatus is disclosed. The exemplary resource management apparatus includes a processor, a resource management circuit, and a second memory. The processor has an internal memory. The resource management circuit has a first memory. An access speed of the first memory is higher than an access speed of the second memory. The resource management circuit is arranged to load a plurality of first resource identifiers stored in the second memory into the first memory, and return a plurality of second resource identifiers stored in the first memory to the second memory. The resource management circuit is further arranged to load a plurality of third resource identifiers stored in the first memory into the internal memory, and return a plurality of fourth resource identifiers stored in the internal memory to the first memory.

According to a second aspect of the present invention, an exemplary resource management method is disclosed. The exemplary resource management method includes: loading a plurality of first resource identifiers stored in a second memory into a first memory, wherein an access speed of the first memory is higher than an access speed of the second memory; returning a plurality of second resource identifiers stored in the first memory to the second memory; loading a plurality of third resource identifiers stored in the first memory into an internal memory of a processor; and returning a plurality of fourth resource identifiers stored in the internal memory to the first memory.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a resource management apparatus according to an embodiment of the present invention.

FIG. 2 is a flowchart illustrating an operation of a resource management circuit that processes a resource identifier allocation request issued from a processor according to an embodiment of the present invention.

FIG. 3 is a diagram illustrating a prefetch operation performed by a resource management circuit under a Case1 condition according to an embodiment of the present invention.

FIG. 4 is a diagram illustrating a prefetch operation performed by a resource management circuit under a Case2 condition according to an embodiment of the present invention.

FIG. 5 is a flowchart illustrating an operation of a resource management circuit 104 that processes a resource identifier release request issued from a processor according to an embodiment of the present invention.

FIG. 6 is a diagram illustrating a pre-return operation performed by a resource management circuit under a Case1 condition according to an embodiment of the present invention.

FIG. 7 is a diagram illustrating a pre-return operation performed by a resource management circuit under a Case2 condition according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

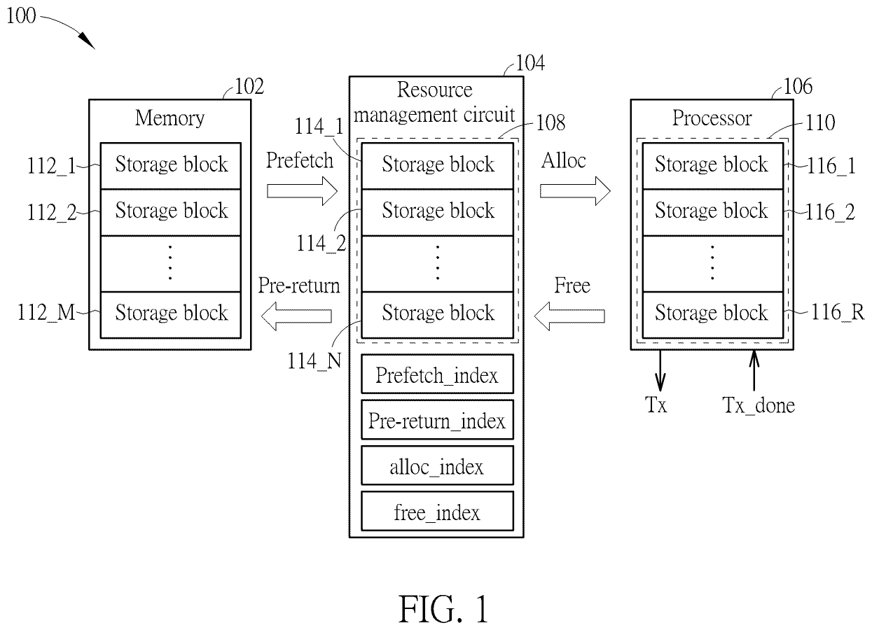

FIG. 1 is a diagram illustrating a resource management apparatus according to an embodiment of the present invention. By way of example, but not limitation, the resource management apparatus 100 may be employed by a network apparatus such as a gateway. The resource management apparatus 100 includes a memory 102, a resource management circuit 104, and a processor 106, wherein the resource management circuit 104 has a memory 108, and the processor 106 has an internal memory 110. For example, the memory 102 is a dynamic random access memory (DRAM), and each of the memory 108 and the internal memory 110 is a static random access memory (SRAM). Regarding the processor 106, the internal memory 110 may be used as a cache memory and thus has the highest access speed. Both of the memory 102 and the memory 108 are external memories, where the access speed of the memory 108 is higher than that of the memory 102. Additionally, the processor 106 may be an NPU, and the resource management circuit 104 may be pure hardware supporting resource identifier management, and may be used to manage resource identifiers to be used by the processor 106. For example, when a packet buffer is initialized, it is partitioned into a plurality of storage blocks according to a fixed block size. These storage blocks in the packet buffer are used to store a plurality of network packets, respectively. In addition, each storage block in the packet buffer is assigned a unique resource identifier Buf-ID. Therefore, the processor 106 may perform network packet forwarding through resource identifiers Buf-ID. It should be noted that this is for illustrative purposes only, and is not meant to be a limitation of the present invention. In other applications, the resource identifier may be an identifier of other resource category (e.g., token-ID). In other words, any apparatus and method using the multi-layer architecture proposed by the present invention to perform resource identifier management falls within the scope of the present invention.

For better comprehension of technical features of the present invention, the following assumes that resource identifiers managed by the resource management circuit 104 are buffer identifiers Buf-ID. In this embodiment, the memory 102 is partitioned into a plurality of storage blocks 112_1-112_M (M>1), the memory 108 is partitioned into a plurality of storage blocks 114_1-114_N (N>1), and the internal memory 110 is partitioned into at least one storage block 116_1-116_R (R≥1). Storage blocks 112_1-112_M and storage blocks 114_1-114_N may have the same block size (e.g., 128 bytes (128B)). The number of storage blocks 112_1-112_M may be greater than the number of storage blocks 114_1-114_N (i.e., M>N); in addition, the block size of each of the storage blocks 114_1-114_N (e.g., 128B) is greater than the block size of each of the storage blocks 116_1-116_R (e.g., 16B), and the number of storage blocks 114_1-114_N is greater than the number of storage blocks 116_1-116_R (i.e., N>R). For example, an ID value of each resource identifier Buf-ID is represented using 16 bits. During initialization, an array of resource identifier Buf-ID is partitioned into a plurality of groups of resource identifier, each having 64 resource identifiers Buf-ID and occupying 128B, and the groups of resource identifiers are stored in the storage blocks 112_1-112_M, respectively. That is, each of the storage blocks 112_1-112_M stores one group of resource identifier Buf-ID (e.g., 64 resource identifiers Buf-ID). Assuming that the resource management apparatus 100 supports 32K resource identifiers Buf-ID (which have index values Buf-ID index set by 0, 1, 2, 3, . . . , 32767, respectively), the resource identifiers Buf-ID can be partitioned into 512 groups of resource identifiers. Therefore, the number of storage blocks 112_1-112_M is 512 (i.e., M=512). Regarding the memory 108 within the resource management circuit 104, each storage block in the storage blocks 114_1-114_N stores one group of resource identifiers Buf-ID (e.g., 64 resource identifiers Buf-ID). In this embodiment, the number of storage blocks 114_1-114_N is 16 (i.e., N=16). In addition, the 64 resource identifiers Buf-ID stored in each of the storage blocks 114_1-114_N can be further partitioned into 8 batches of resource identifiers, each batch having 8 resource identifiers Buf-ID. Regarding the internal memory 110 of the processor 106, each of the storage blocks 116_1-116_R stores one batch of resource identifiers Buf-ID (e.g., 8 resource identifiers Buf-ID).

The resource management circuit 104 is arranged to load a plurality of resource identifiers stored in the memory (e.g., DRAM) 102 into the memory (e.g., SRAM) 108, and return a plurality of resource identifiers stored in the memory (e.g., SRAM) 108 to the memory (e.g., DRAM) 102. In addition, the resource management circuit 104 is further arranged to load a plurality of resource identifiers stored in the memory (e.g., SRAM) 108 into the internal memory (e.g., SRAM) 110 of the processor 106, and return a plurality of resource identifiers stored in the internal memory (e.g., SRAM) 110 of the processor 106 to the memory (e.g., SRAM) 108. In this embodiment, when a specific condition is met, the resource management circuit 104 automatically performs a prefetch operation to load a plurality of resource identifiers stored in the memory (e.g., DRAM) 102 into the memory (e.g., SRAM) 108; when another specific condition is met, the resource management circuit 104 automatically performs pre-return operation to return a plurality of resource identifiers stored in the memory (e.g., SRAM) 108 to the memory (e.g., DRAM) 102; in response to a resource identifier allocation (alloc) request issued from the processor 106, the resource management circuit 104 loads a plurality of resource identifiers stored in the memory (e.g., SRAM) 108 into the internal memory (e.g., SRAM) 110 of the processor 106; and in response to a resource identifier release (free) request issued from the processor 106, the resource management circuit 104 returns a plurality of resource identifiers stored in the internal memory (e.g., SRAM) 110 of the processor 106 to the memory (e.g., SRAM) 108.

In this embodiment, the prefetch/pre-return operation between the resource management circuit 104 and the memory 102 uses a group of resource identifiers Buf-ID (e.g., 64 resource identifiers Buf-ID) as a basic processing unit, and the resource identifier allocation/release operation between the resource management circuit 104 and the processor 106 uses a batch of resource identifiers Buf-ID (e.g., 8 resource identifiers) as a basic processing unit. In addition, the resource management circuit 104 maintains a plurality of indexes Prefetch_index, Pre-return_index, alloc_index, and free_index, such that dynamic management of resource identifiers Buf-ID can be achieved through these indexes.

The indexes Prefetch_index and Pre-return_index are used to indicate usage statuses of groups of resource identifiers Buf-ID (which are basic processing units, each group having 64 resource identifiers, in the memory 102). Therefore, whenever the memory 102 provides a group of resource identifiers Buf-ID (e.g., 64 resource identifiers) to the memory 108, the index Prefetch_index will be incremented by 1 (i.e., Prefetch_index=Prefetch_index+1). Similarly, whenever the memory 108 returns a group of resource identifiers Buf-ID (e.g., 64 resource identifiers) to the memory 102, the index Pre-return_index will be incremented by 1 (i.e., Pre-return_index=Pre-return_index+1). During an initialization procedure, the resource management circuit 104 preloads 16 groups of resource identifiers Buf-ID (e.g., the 0^{th} group of resource identifiers Buf-ID to the 15^{th} group of resource identifiers Buf-ID) from the memory 102 into 16 storage blocks 114_1-114_N (N=16) allocated in the memory 108, respectively. Therefore, an initial value of the index Prefetch_index is set by 16 (i.e., Prefetch_index=16), meaning that the next prefetch operation should read the 16th group of resource identifiers Buf-ID from the memory 102. In addition, since no pre-return operation is triggered during the initialization procedure, an initial value of the index Pre-return_index is set by 0 (i.e., Pre-return_index=0), meaning that the 1^{st} pre-return operation should overwrite the 0^{th} group of resource identifiers Buf-ID in the memory 102.

The indexes alloc_index and free_index are used to indicate usage statuses of batches of resource identifiers Buf-ID (which are basic processing units, each batch having 8 resource identifiers per group, in the memory 108). Since no resource identifier allocation/release operations are triggered during the initialization procedure, an initial value of the index alloc_index is set by 0 (i.e., alloc_index=0), meaning that the 1^{st} resource identifier allocation operation should read the 0^{th} batch of resource identifiers Buf-ID in the memory 108, and an initial value of the index free_index is set by 0 (i.e., free_index=0), meaning that the 1^{st} resource identifier release operation should overwrite the 0^{th} batch of resource identifiers Buf-ID in the memory 108. In addition, during the subsequent resource identifier management process, whenever the memory 102 provides a group of resource identifiers Buf-ID (e.g., 64 resource identifiers) to the memory 108, the index free_index will be incremented by 8 (i.e., free_index=free_index+8); whenever the memory 108 returns a group of resource identifiers Buf-ID (e.g., 64 resource identifiers) to the memory 102, the index alloc_index will be incremented by 8 (i.e., alloc_index=alloc_index+8); whenever the memory 108 provides a batch of resource identifiers Buf-ID (e.g., 8 resource identifiers) to the internal memory 110, the index alloc_index will be incremented by 1 (i.e., alloc_index=alloc_index+1); and whenever the internal memory 110 returns a batch of resource identifiers Buf-ID (e.g., 8 resource identifiers) to the memory 108, the index free_index will be incremented by 1 (i.e., free_index=free_index+1).

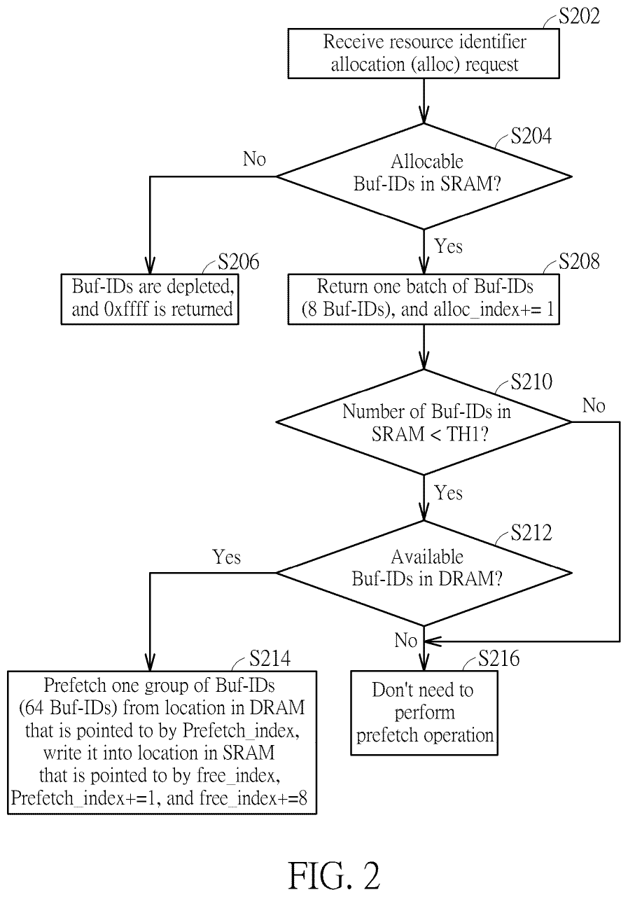

FIG. 2 is a flowchart illustrating an operation of the resource management circuit 104 that processes a resource identifier allocation request issued from the processor 106 according to an embodiment of the present invention. Provided that the result is substantially the same, the steps are not required to be executed in the exact order shown in FIG. 2. When the processor (e.g., NPU) 106 deals with network packet forwarding, it needs to request a resource identifier Buf-ID (which corresponds to a storage block in the packet buffer, where the storage block is used to buffer a network packet to be forwarded) from the resource management circuit 104 for the network packet to be forwarded. In step S202, the resource management circuit 104 receives the resource identifier allocation request issued from the processor 106. In step S204, the resource management circuit 104 first determines whether the memory (e.g., SRAM) 108 has allocable resource identifiers Buf-ID. For example, the resource management circuit 104 checks if the indexes alloc_index and free_index meet the following conditions.

$$( alloc\_index + 1 ) \%128 != free\_index \qquad ( 1 )$$

In this embodiment, each storage block included in the storage blocks 114_1-114_N is used to store 8 batches of resource identifiers Buf-ID, and the number of storage blocks 114_1-114_N is 16 (i.e., N=16). Since the storage blocks 114_1-114_N are used in a manner similar to that of a ring buffer, each of the indexes alloc_index and free_index increases from the minimum value 0 to the maximum value 127 (i.e., 127=8*16−1), and then rolls back to the minimum value 0. Therefore, the condition (1) is to determine whether the index alloc_index is about to catch up with the index free_index. If (alloc_index+1)%128=free_index, this means that all resource identifiers Buf-ID stored in the memory 108 have been allocated, and there are no resource identifiers Buf-ID available in the memory 108. This also means that there are no spare resource identifiers available in the memory 102, which is detailed in steps S210 and S212. Since the processor 106 has depleted all resource identifiers Buf-ID (which also means that all resource identifiers Buf-ID in the memory 102 have been depleted), the flow proceeds to step S206 for returning an allocation failure message (e.g., 0xffff) to the processor 106. On the other hand, if (alloc_index+1)%128!=free_index, it means that unallocated resource identifiers Buf-ID are still available in the memory 108. Therefore, the flow proceeds to step S208 to return a batch of resource identifiers Buf-ID (e.g., 8 resource identifiers) to the processor 106 and update the index alloc_index accordingly (i.e., alloc_index=alloc_index+1).

The resource management circuit 104 subsequently checks whether a prefetch operation is needed to replenish new resource identifiers Buf-ID to the memory 108. In this embodiment, the resource management circuit 104 determines whether the number of allocable resource identifiers Buf-ID stored in the memory 108 is less than a predetermined threshold TH1 (e.g., TH1=12%) and/or whether the memory 102 has allocable resource identifiers Buf-ID. Specifically, the prefetch operation is performed only when the number of allocable resource identifiers Buf-ID stored in the memory 108 is less than the predetermined threshold TH1 (e.g., TH1=12%) and the memory 102 has allocable resource identifiers. It should be noted that the execution order of steps S210 and S212 may be interchangeable.

As mentioned above, the storage blocks 114_1-114_N are used in a manner similar to that of a ring buffer. Therefore, the index alloc_index increases from the minimum value 0 to the maximum value 127 (i.e., 127=8*16-1), and then rolls back to the minimum value 0. Similarly, the index free_index increases from the minimum value 0 to the maximum value 127 (i.e., 127=8*16-1), and then rolls back to the minimum value 0. Basically, the index free_index chases the index alloc_index, and is less than the index alloc_index. However, after the index alloc_index reaches its maximum value 127 and rolls back to its minimum value 0, the index alloc_index becomes less than the index free_index. Therefore, there are two conditions between indexes free_index and alloc_index, including a Case1 condition (alloc_index>free_index) and a Case2 condition (free_index>alloc_index). Thus, determining whether the number of allocable resource identifiers Buf-ID stored in the memory 108 is less than a predetermined threshold TH1 (e.g., TH1=12%) can be expressed using the following pseudo codes.

```
if (alloc_index > free_index)//Case1
  [(128 − alloc_index + free_index)/128]*10 <= 1.2;
else//Case2
  [(free_index − alloc_index)/128] *10 <= 1.2
```

In addition, the resource management circuit 104 checks if the indexes Prefetch_index and Pre-return_index meet the following conditions to determine whether the memory 102 has allocable resource identifiers Buf-ID.

$$( Prefetch\_index + 1 ) \%512 != Pre - return\_index \qquad ( 2 )$$

In this embodiment, each storage block included in the storage blocks 112_1-112_M stores one group of resource identifiers Buf-ID (e.g., 64 resource identifiers), and the number of storage blocks 112_1-112_M is 512 (i.e., M=512). Since the storage blocks 112_1-112_M are used in a manner similar to that of a ring buffer, each of the indexes Prefetch_index and Pre-return_index increases from the minimum value 0 to the maximum value 511, and then rolls back to the minimum value 0. Therefore, condition (2) is to determine whether the index Prefetch_index is about to catch up with the index Pre-return_index. If (Prefetch_index+1)%512=Pre-return_index, this means that all resource identifiers Buf-ID stored in the memory 102 have been provided to the resource management circuit 104 through prefetch operations. On the other hand, if (Prefetch_index+1)%512!=Pre-return_index, this means that the memory 102 still has resource identifiers Buf-ID that have not yet been provided to the resource management circuit 104 through prefetch operations.

When the number of allocable resource identifiers Buf-ID stored in the memory 108 is greater than the predetermined threshold TH1 (e.g., TH1=12%) or the memory 102 does not have allocable resource identifiers Buf-ID, the resource management circuit 104 does not need to perform a prefetch operation (step S216). On the other hand, when the number of allocable resource identifiers Buf-ID stored in the memory 108 is less than the predetermined threshold TH1 (e.g., TH1=12%) and the memory 102 has allocable resource identifiers Buf-ID, the flow proceeds to step S214. In step S214, the resource management circuit 104 prefetches one group of resource identifiers Buf-ID (e.g., 64 resource identifiers) from a location in the memory (e.g., DRAM) 102 that is pointed to by the index Prefetch_index, and writes it into a location in the memory (e.g., SRAM) 108 that is pointed to by the index free_index. In addition, the resource management circuit 104 updates the index Prefetch_index (e.g., Prefetch_index=Prefetch_index+1) and the index free_index (e.g., free_index=free_index+8).

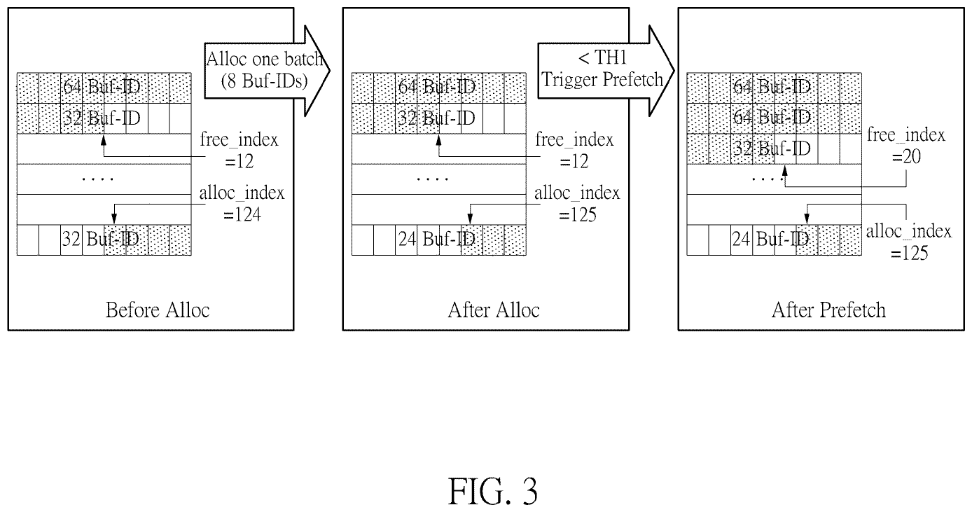

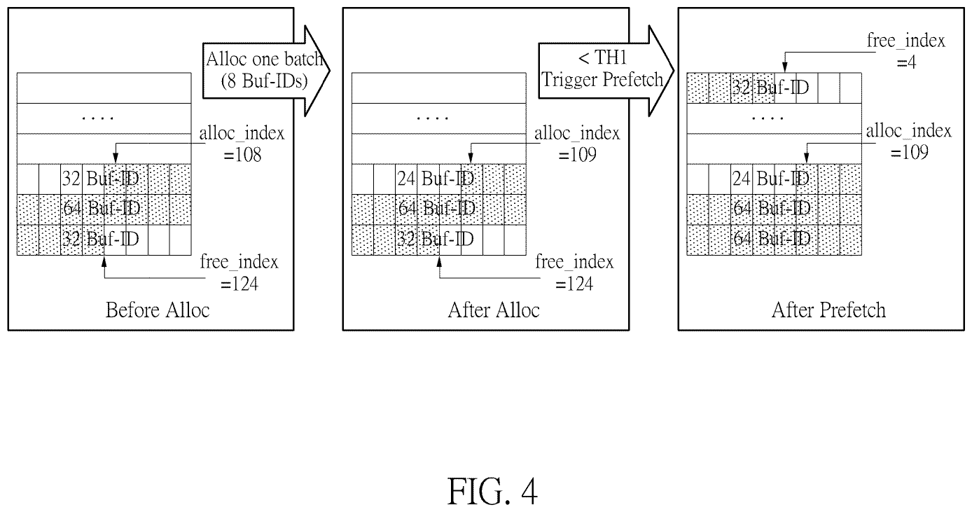

FIG. 3 is a diagram illustrating a prefetch operation performed by the resource management circuit 104 under a Case1 condition according to an embodiment of the present invention. FIG. 4 is a diagram illustrating a prefetch operation performed by the resource management circuit 104 under a Case2 condition according to an embodiment of the present invention. Assume that the memory 102 currently has allocable resource identifiers Buf-ID. As shown in FIG. 3, after the resource management circuit 104 returns a batch of resource identifiers Buf-ID (e.g., 8 resource identifiers) to the processor 106 in response to the allocation request issued from the processor 106, the index alloc_index is updated from 124 to 125 (i.e., 125=(124+1)%128). At this moment, alloc_index=125>free_index=12. Since the trigger condition of the prefetch operation is met (Case1: [(128−125+12)/128]*10=1.17<=1.2), the resource management circuit 104 reads a group of resource identifiers Buf-ID (e.g., 64 resource identifiers) from the memory 102, and writes it into the memory 108. At this moment, the index free_index is updated from 12 to 20 (i.e., 20=(12+8)%128). Although it is not illustrated, it can be known from the above description that the index Prefetch_index of the memory 102 is incremented by 1 at this moment. As shown in FIG. 4, after the resource management circuit 104 returns a batch of resource identifiers Buf-ID (e.g., 8 resource identifiers) to the processor 106 in response to the allocation request issued from the processor 106, the index alloc_index is updated from 108 to 109 (i.e., 109=(108+1)%128). At this moment, free_index=124>alloc_index=109. Since the trigger condition of the prefetch operation is met (Case2: [(124−109)/128]*10=1.17<=1.2), the resource management circuit 104 reads a group of resource identifiers Buf-ID (e.g., 64 resource identifiers) from the memory 102, and writes it into the memory 108. At this moment, the index free_index is updated from 124 to 4 (i.e., 4=(124+8)%128). Although it is not illustrated, it can be known from the above description that the index Prefetch_index of the memory 102 is incremented by 1 at this moment.

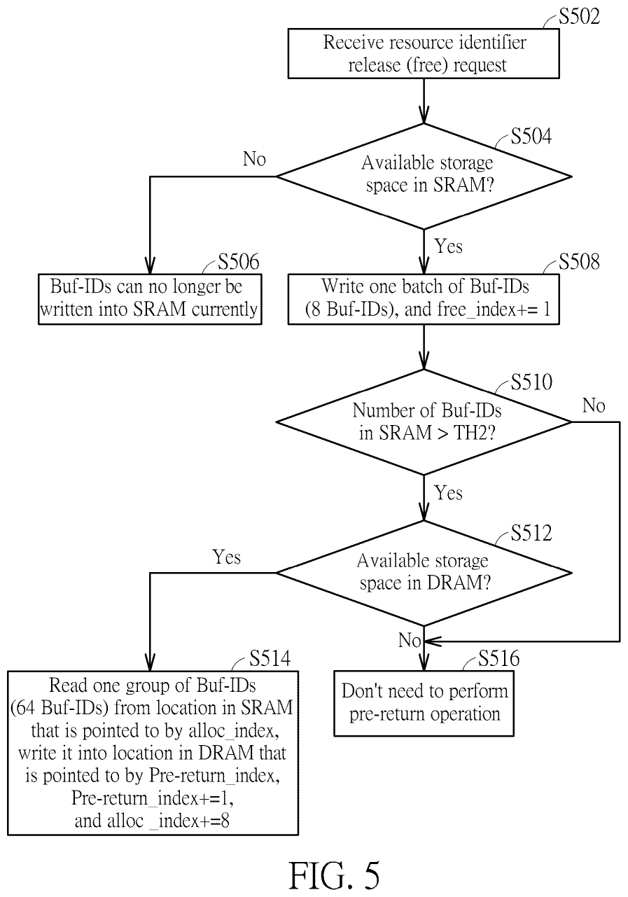

FIG. 5 is a flowchart illustrating an operation of the resource management circuit 104 for processing a resource identifier release request issued from the processor 106 according to an embodiment of the present invention. If the result is substantially the same, the steps are not required to be executed in the exact order shown in FIG. 5. The processor (e.g., NPU) 106 initiates transmission (Tx) of network packets for network packet forwarding. After receiving the indication Tx done indicating that the transmission is completed and release of occupied resources is started, the corresponding resource identifiers Buf-ID can be released for use by subsequent network packets. Therefore, the processor (e.g., NPU) 106 needs to release resource identifiers Buf-ID (which are occupied by network packets that have been forwarded) through the resource management circuit 104, where the occupied resource identifiers Buf-ID correspond to storage blocks in the packet buffer. In step S502, the resource management circuit 104 receives the resource identifier release request issued from the processor 106. In step S504, the resource management circuit 104 first determines whether the memory (e.g., SRAM) 108 has available storage space. For example, the resource management circuit 104 checks if the indexes alloc_index and free_index meet the following conditions.

$$( free\_index + 1 ) \%128 != alloc\_index \qquad ( 3 )$$

In this embodiment, each storage block included in the storage blocks 114_1-114_N stores 8 batches of resource identifiers Buf-ID, and the number of storage blocks 114_1-114_N is 16 (i.e., N=16). Since the storage blocks 114_1-114_N are used in a manner similar to that of a ring buffer, each of the indexes free_index and alloc_index increases from the minimum value 0 to the maximum value 127 (i.e., 127=8*16-1), and then rolls back to the minimum value 0. Therefore, condition (3) is for determining whether the index free_index is about to catch up with the index alloc_index. If (free_index+1)%128=alloc_index, this means that the memory 108 has no space with overwritable resource identifiers Buf-ID, and therefore there are no more new resource identifiers Buf-ID allowed to be written into the memory 108. This also means there is no free space in the memory 102 that is available for storing resource identifiers (which is detailed in steps S510 and S512). Therefore, the flow proceeds to step S506 to return a release failure message to the processor 106. On the other hand, if (free_index+1)%128!=alloc_index, this means that the memory 108 still has overwritable resource identifiers Buf-ID. Therefore, the flow proceeds to step S508 to write a batch of resource identifiers Buf-ID (e.g., 8 resource identifiers) from the internal memory 110 of the processor 106 to the memory 108 for releasing these resource identifiers Buf-ID occupied by network packets that have been forwarded. In addition, the index free_index is updated at the same time (i.e., free_index=free_index+1).

The resource management circuit 104 subsequently checks whether a pre-return operation is needed to return a portion of the allocable resource identifiers Buf-ID in the memory 108 to the memory 102. In this embodiment, the resource management circuit 104 determines whether the number of allocable resource identifiers Buf-ID stored in the memory 108 is higher than a predetermined threshold TH2 (e.g., TH2=88%) and/or whether the memory 102 has available storage space. Specifically, the pre-return operation is performed only when the number of allocable resource identifiers Buf-ID stored in the memory 108 is higher than the predetermined threshold TH2 (e.g., TH2=88%) and the memory 102 has available storage space. It should be noted that the execution order of steps S510 and S512 may be interchangeable.

As mentioned above, the storage blocks 114_1-114_N are used in a manner similar to that of a ring buffer. Therefore, the index alloc_index increases from the minimum value 0 to the maximum value 127 (i.e., 127=8*16−1), and then rolls back to the minimum value 0. Similarly, the index free_index increases from the minimum value 0 to the maximum value 127 (i.e., 127=8*16−1), and then rolls back to the minimum value 0. Basically, the index alloc_index leads the index free_index. Therefore, the index free_index is smaller than the index alloc_index. However, after the index alloc_index reaches its maximum value 127 and rolls back to its minimum value 0, the index alloc_index becomes smaller than the index free_index. Therefore, there are two conditions between the indexes free_index and alloc_index, including a Case1 condition (alloc_index>free_index) and a Case2 condition (free_index>alloc_index). Thus, determining whether the number of allocable resource identifiers Buf-ID stored in the memory 108 is higher than the predetermined threshold TH2 (e.g., TH2=88%) may be expressed using the following pseudo codes.

```
if (alloc_index > free_index)//Case1
  [(128 − alloc_index + free_index)/128]*10 >= 8.8;
else//Case2
  [(free_index − alloc_index)/128] *10 >= 8.8
```

In addition, the resource management circuit 104 checks if the indexes Prefetch_index and Pre-return_index meet the following conditions to determine whether the memory 102 has available storage space.

$$( Pre - return\_index + 1 ) \%512 != Prefetch\_index \qquad ( 4 )$$

In this embodiment, each storage block included in the storage blocks 112_1-112_M stores one group of resource identifiers Buf-ID (e.g., 64 resource identifiers), and the number of storage blocks 112_1-112_M is 512 (i.e., M=512). Since the storage blocks 112_1-112_M are used in a manner similar to that of a ring buffer, each of the indexes Prefetch_index and the Pre-return_index increases from the minimum value 0 to the maximum value 511, and then rolls back to the minimum value 0. Therefore, condition (4) is to determine whether the index Pre-return_index is about to catch up with the index Prefetch_index. If (Pre-return_index+1)%512=Prefetch_index, this means that there are no more overwritable resource identifiers Buf-ID in the memory 102. On the other hand, if (Pre-return_index+1)%512!=Prefetch_index, this means that the memory 102 still has overwritable resource identifiers Buf-ID.

When the number of allocable resource identifiers Buf-ID stored in the memory 108 is lower than the predetermined threshold TH2 (e.g., TH2=88%) or the memory 102 does not have available storage space, the resource management circuit 104 does not need to perform a pre-return operation (step S516). On the other hand, when the number of allocable resource identifiers Buf-ID stored in the memory 108 is higher than the predetermined threshold TH2 (e.g., TH2=88%) and the memory 102 has available storage space, the flow proceeds to step S514. In step S514, the resource management circuit 104 reads a group of resource identifiers Buf-ID (e.g., 64 resource identifiers) from a location in the memory 108 (e.g., SRAM) that is pointed to by alloc_index, and writes it into a location in the memory 102 (e.g., DRAM) that is pointed to by Pre-return_index. In addition, the resource management circuit 104 updates the index Pre-return_index (e.g., Pre-return_index=Pre-return_index+1) and the index alloc_index (e.g., alloc_index=alloc_index+8).

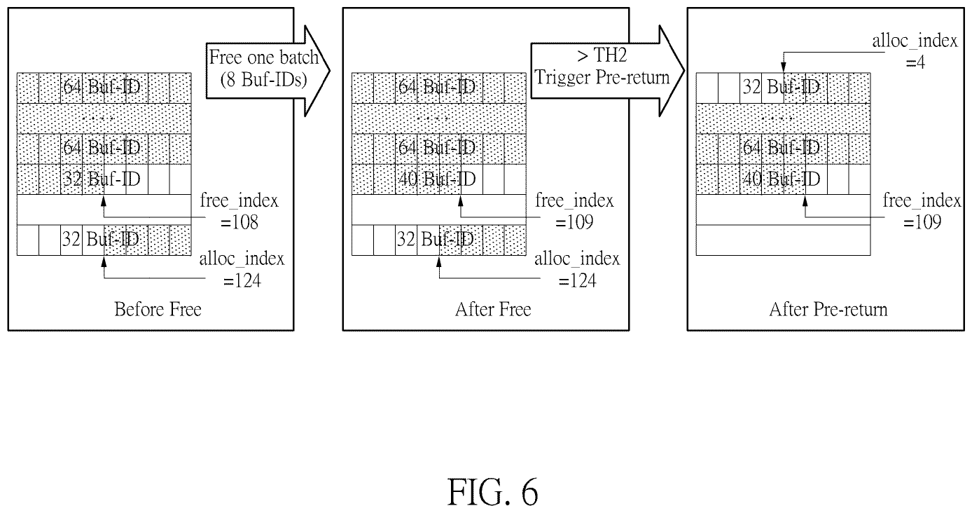

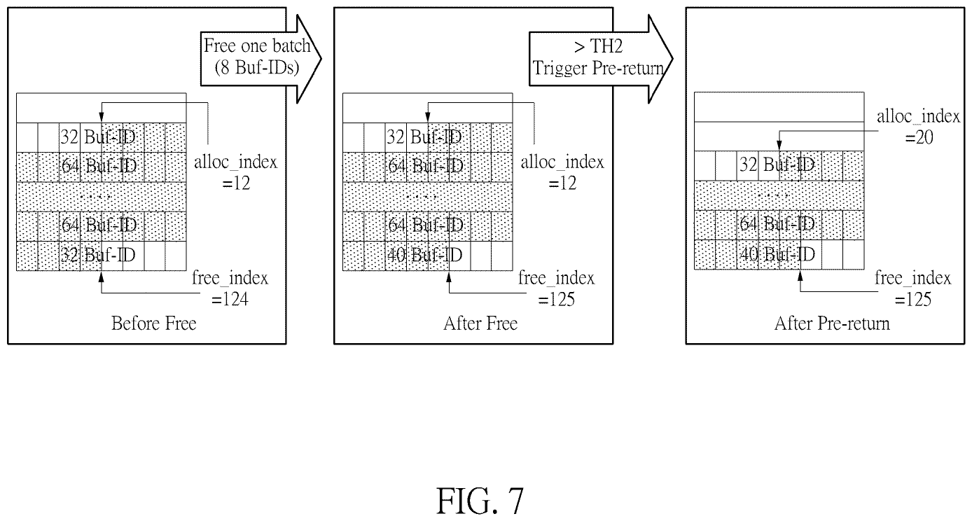

FIG. 6 is a diagram illustrating a pre-return operation performed by the resource management circuit 104 under a Case1 condition according to an embodiment of the present invention. FIG. 7 is a diagram illustrating a pre-return operation performed by the resource management circuit 104 under a Case2 condition according to an embodiment of the present invention. Assume that the memory 102 currently has available storage space. As shown in FIG. 6, after the resource management circuit 104 writes a batch of resource identifiers Buf-ID (e.g., 8 resource identifiers) in response to a release request issued from the processor 106, the index free_index is updated from 108 to 109 (i.e., 109=(108+1)%128). At this moment, alloc_index=124>free_index=109. Since the trigger condition of the pre-return operation is met (Case1: [(128-124+109)/128]*10=8.82>=8.8), the resource management circuit 104 reads a group of resource identifiers Buf-ID (e.g., 64 resource identifiers) from the memory 108, and writes it into the memory 102. At this moment, the index alloc_index is updated from 124 to 4 (i.e., 4=(124+8)%128). Although it is not illustrated, it can be known from the above description that the index Pre-return_index of the memory 102 is incremented by 1 at this moment. As shown in FIG. 7, after the resource management circuit 104 writes a batch of resource identifiers Buf-ID (e.g., 8 resource identifiers) in response to a release request issued from the processor 106, the index free_index is updated from 124 to 125 (i.e., 125=(124+1)%128). At this moment, free_index=125>alloc_index=12. Since the trigger condition of the pre-return operation is met (Case2: [(125−12)/128]*10=8.82>=8.8), the resource management circuit 104 reads a group of resource identifiers Buf-ID (e.g., 64 resource identifiers) from the memory 108, and writes it into the memory 102. At this moment, the index alloc_index is updated from 12 to 20 (i.e., 20=(12+8)%128). Although it is not illustrated, it can be known from the above description that the index Pre-return_index of the memory 102 is incremented by 1 at this moment.

In summary, the present invention employs a multi-layer architecture to perform resource identifier management. The memory (e.g., DRAM) 102 has a large storage capacity and can therefore be used to store all resource identifiers Buf-ID (e.g., 10K to 100K resource identifiers Buf-ID, occupying a space of 20 KB to 200 KB). The memory (e.g., SRAM) 108 is used as a buffer and can store only a portion of the resource identifiers Buf-ID (e.g., 1K resource identifiers Buf-ID, occupying a space of 2 KB). In addition, the internal memory (e.g., SRAM) 110 serves as a cache memory of the processor 106 and can store a smaller number of resource identifiers Buf-ID (e.g., 8 resource identifiers Buf-ID, occupying a space of 16B).

Regarding the memory (e.g., SRAM) 108, only one read and one write are required to be executed every 8 network packets. Regarding the memory (e.g., DRAM) 102, in the worst case, one read and one write are required to be executed every 64 network packets. However, in most cases, it is not necessary to frequently read from and write to the memory (e.g., DRAM) 102. This is mainly because the processor 106 can release resource identifiers Buf-ID back to the memory (e.g., SRAM) 108 of the resource management circuit 104, so that these released resource identifiers Buf-ID can be re-allocated by the resource management circuit 104. Therefore, the resource identifiers Buf-ID stored in memory (e.g., SRAM) 108 can be regarded as hotspot IDs that can be reused continuously. As long as the trigger threshold of the prefetch operation or the trigger threshold of the pre-return operation is not reached, there is no need to access the memory (e.g., DRAM) 102. When the network packet rate is stable, the processor 106 will reach a balance between allocation and release of resource identifiers Buf-ID, and the number of occupied resource identifiers Buf-ID will not fluctuate much. There will be no frequent exchange of resource identifiers between the memory (e.g., DRAM) 102 and the memory (e.g., SRAM) 108. On the other hand, when the network packet rate increases, decreases, or becomes unstable, the number of occupied resource identifiers Buf-ID may fluctuate significantly. At this moment, it is required to exchange resource identifiers between the memory (e.g., DRAM) 102 and the memory (e.g., SRAM) 108.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A resource management apparatus comprising:
a processor, comprising an internal memory;
a resource management circuit, comprising a first memory; and
a second memory, wherein an access speed of the first memory is higher than an access speed of the second memory;
wherein the resource management circuit is arranged to load a plurality of first resource identifiers stored in the second memory into the first memory, and return a plurality of second resource identifiers stored in the first memory to the second memory; and
the resource management circuit is further arranged to load a plurality of third resource identifiers stored in the first memory into the internal memory, and return a plurality of fourth resource identifiers stored in the internal memory to the first memory.

2. The resource management apparatus of claim 1, wherein the resource management circuit is further arranged to receive a resource identifier allocation request issued from the processor; and in response to the resource identifier allocation request, the resource management circuit loads the plurality of third resource identifiers into the internal memory.

3. The resource management apparatus of claim 2, wherein in response to the resource identifier allocation request, the resource management circuit is further arranged to determine whether the first memory has allocable resource identifiers; and when determining that the first memory has allocable resource identifiers, the resource management circuit loads the plurality of third resource identifiers into the internal memory.

4. The resource management apparatus of claim 2, wherein after the plurality of third resource identifiers have been loaded into the internal memory, the resource management circuit is further arranged to determine whether a number of allocable resource identifiers stored in the first memory is lower than predetermined threshold, and determine whether the second memory has allocable resource identifiers; and when determining that the number of allocable resource identifiers stored in the first memory is lower than the predetermined threshold and the second memory has allocable resource identifiers, the resource management circuit loads the plurality of first resource identifiers into the first memory.

5. The resource management apparatus of claim 1, wherein the resource management circuit is further arranged to receive a resource identifier release request issued from the processor; and in response to the resource identifier release request, the resource management circuit returns the plurality of fourth resource identifiers to the first memory.

6. The resource management apparatus of claim 5, wherein in response to the resource identifier release request, the resource management circuit is further arranged to determine whether the first memory has available storage space; and when determining that the first memory has available storage space, the resource management circuit returns the plurality of fourth resource identifiers to the first memory.

7. The resource management apparatus of claim 5, wherein after the plurality of fourth resource identifiers have been returned to the first memory, the resource management circuit is further arranged to determine whether a number of allocable resource identifiers stored in the first memory is higher than a predetermined threshold and determine whether the second memory has available storage space; and when determining that the number of allocable resource identifiers stored in the first memory is higher than the predetermined threshold and the second memory has available storage space, the resource management circuit returns the plurality of second resource identifiers to the second memory.

8. The resource management apparatus of claim 1, wherein the processor is a network processing unit (NPU).

9. The resource management apparatus of claim 1, wherein each of the internal memory and the first memory is a static random access memory (SRAM), and the second memory is a dynamic random access memory (DRAM).

10. The resource management apparatus of claim 1, wherein each resource identifier corresponds to a storage block in a packet buffer, where the storage block is arranged to buffer a network packet.

11. A resource management method comprising:
loading a plurality of first resource identifiers stored in a second memory into a first memory, wherein an access speed of the first memory is higher than an access speed of the second memory;
returning a plurality of second resource identifiers stored in the first memory to the second memory;
loading a plurality of third resource identifiers stored in the first memory into an internal memory of a processor; and
returning a plurality of fourth resource identifiers stored in the internal memory to the first memory.

12. The resource management method of claim 11, further comprising:
receiving a resource identifier allocation request issued from the processor;
wherein loading the plurality of third resource identifiers stored in the first memory into the internal memory of the processor comprises:
in response to the resource identifier allocation request, loading the plurality of third resource identifiers into the internal memory.

13. The resource management method of claim 12, wherein in response to the resource identifier allocation request, loading the plurality of third resource identifiers into the internal memory comprises:
determining whether the first memory has allocable resource identifiers; and
in response to determining that the first memory has allocable resource identifiers, loading the plurality of third resource identifiers into the internal memory.

14. The resource management method of claim 12, wherein loading the plurality of first resource identifiers stored in the second memory into the first memory comprises:
after the plurality of third resource identifiers have been loaded into the internal memory, determining whether a number of allocable resource identifiers stored in the first memory is lower than a predetermined threshold, and determining whether the second memory has allocable resource identifiers; and
in response to determining that the number of allocable resource identifiers stored in the first memory is lower than the predetermined threshold and the second memory has allocable resource identifiers, loading the plurality of first resource identifiers into the first memory.

15. The resource management method of claim 11, further comprising:
receiving a resource identifier release request issued from the processor;
wherein returning the plurality of fourth resource identifiers stored in the internal memory to the first memory comprises:
in response to the resource identifier release request, returning the plurality of fourth resource identifiers to the first memory.

16. The resource management method of claim 15, wherein in response to the resource identifier release request, returning the plurality of fourth resource identifiers to the first memory comprises:
determining whether the first memory has available storage space; and
in response to determining that the first memory has available storage space, returning the plurality of fourth resource identifiers to the first memory.

17. The resource management method of claim 15, wherein returning the plurality of second resource identifiers stored in the first memory to the second memory comprises:
after the plurality of fourth resource identifiers have been returned to the first memory, determining whether a number of allocable resource identifiers stored in the first memory is higher than a predetermined threshold, and determining whether the second memory has available storage space; and
in response to determining that the number of allocable resource identifiers stored in the first memory is higher than the predetermined threshold and the second memory has available storage space, returning the plurality of second resource identifiers to the second memory.

18. The resource management method of claim 11, wherein the processor is a network processing unit (NPU).

19. The resource management method of claim 11, wherein each of the internal memory and the first memory is a static random access memory (SRAM), and the second memory is a dynamic random access memory (DRAM).

20. The resource management method of claim 11, wherein each resource identifier corresponds to a storage block in a packet buffer, where the storage block is arranged to buffer a network packet.
